(19) United States
(12) Patent Application Publication
(10) Pub. No.: US 2009/0035411 A1
(43) Pub. Date: Feb. 5, 2009

(54) Solid free-form fabrication apparatus and method

(76) Inventors: James Seibert, White Oak, PA (US); Michael Rynerson, St. Petersburg, FL (US)

Correspondence Address: IP & INTERNET LAW NORTH, LLC, P.O. BOX 38, ZELIENOPLE, PA, 16063, US

(21) Appl. No.: 11/919,811

(22) PCT Filed: May 6, 2006
(86) PCT No.: PCT/US2006/017254

§ 371 Date: Jan. 17, 2008

Related U.S. Application Data
(60) Provisional application No. 60/678,524, filed on May 6, 2005.

(51) Int. Cl. B29C 35/08

(52) U.S. Cl. 425/174; 264/497; 264/405

(57) ABSTRACT

Apparatuses and methods are described for supplying powder for solid free-form fabrication from a powder supply reservoir (2) that is movable from a servicing position to a dispensing position. The powder supply reservoir may be supported by a horizontally retractable support arm (4). It may also be supported by a support pivot (22), and the support pivot may comprise a horizontally retractable support arm. These features add the convenience of permitting the powder supply reservoir to be serviced outside of a housing that encloses the solid free-form fabrication apparatus during the article-building operation.

### CROSS-REFERENCE TO RELATED APPLICATIONS

This application claims priority to U.S. Provisional Application No. 60/678,524, filed May 6, 2006, which is incorporated by reference herein in its entirety.

### FIELD OF INVENTION

The present invention is in the field of solid free-form fabrication. More particularly, the present invention relates to apparatuses and methods for supplying powder for solid free-form fabrication.

### DESCRIPTION OF PRIOR ART

In recent years, solid free-form fabrication processes have been developed for producing a physical article directly from an electronic representation of the article. The term “solid free-form fabrication process” (“SFFF”) as used herein and in the appended claims refers to any process that results in a three-dimensional physical article and includes a step of sequentially forming the shape of the article one layer at a time from an electronic representation of the article. SFFF processes are also known in the art as “layered manufacturing processes.” They are also sometimes referred to in the art as “rapid prototyping processes” when the layer-by-layer building process is used to produce a small number of a particular article. A SFFF process may include one or more post-shape forming operations that enhance the physical and/or mechanical properties of the article. Examples of SFFF processes include the three-dimensional printing (“3DP”) process, the Selective Laser Sintering (“SLS”) process, the selective laser melting process, and electron beam free-form fabrication processes. An example of the 3DP process may be found in U.S. Pat. No. 6,036,777 to Sachs, issued Mar. 14, 2000. An example of the SLS process may be found in U.S. Pat. No. 5,076,869 to Bourell et al., issued Dec. 31, 1991. An example of the selective laser melting process may be found in U.S. Pat. No. 6,215,093 to Meiners et al., issued Apr. 10, 2001. An example of an electron beam free-form fabrication process may be found in United States Patent Application Publication No. US 2004/0026807 of Andersson et al., published Feb. 14, 2004.

SFFF processes in accordance with the present invention can be used to produce articles comprised of metal, polymeric, ceramic, composite, and other materials. The development of SFFF processes has produced a quantum jump reduction in the time and costs incurred in going from concept to manufactured article by eliminating costly and time-consuming intermediate steps that were traditionally necessary.

SFFF processes of interest to the present invention include the basic steps of: (1) applying and smoothing out a first layer of a powder build material to a vertically indexable build stage; (2) scanning the build material layer with the printing mechanism to impart to it the image of the relevant two-dimensional layer of the article being built; (3) lowering the stage to receive another layer of build material; and (4) repeating steps (1) through (3) until the article is completed. The layer-by-layer construction results in the formation of the desired physical article. Subsequent processing is often employed to enhance the physical properties of the constructed physical article.

The term “printing mechanism” as used herein and in the appended claims generically refers to the component of the SFFF system that (1) physically imparts the image of the relevant two-dimensional layer of the article that is being constructed onto a construction material that is upon the stage upon which the article is being built, and/or (2) deposits a layer of a construction material in the image of such a two-dimensional layer upon the stage or a previous layer. For example, in the 3DP process, the printing mechanism is a print head comprising one or more print jets and associated scanning and control mechanisms that spray droplets of a binder fluid onto a powder layer to form the image of the relevant two-dimensional layer of the physical article. In the SLS and the selective laser melting processes, the printing mechanism is a laser and associated scanning and control mechanisms that scan a laser beam across a powder layer to fuse powder therein together in the form of the image of the relevant two-dimensional layer of the physical article. Similarly, in the electron beam free-form fabrication process, the printing mechanism is the electron beam ray gun and the associated scanning and control mechanisms that scan the electron beam across a powder layer to fuse powder therein together in the form of the image of the relevant two-dimensional layer of the physical article.

Typically, SFFF apparatuses that use powder as a building material employ two similar chambers situated side-by-side. One is a build chamber and the other is a powder supply chamber. Each is essentially an open-top box having a vertically-indexable platform as the box bottom. At the start of the operation, the build chamber platform is raised to the level that is just below the top of the chamber's sidewalls and the supply chamber's platform is at its lowest position and powder fills the supply chamber to the top of that chamber's sidewalls. The respective platforms of the build and supply chambers operate in reciprocal tandem, i.e., as the build chamber platform indexes downward to receive a layer of powder, the supply chamber platform indexes upward to allow a layer of powder to be wiped away and into the supply chamber. Often a roller is used as the wiping mechanism and the roller rotates counter to its motion of travel as it wipes powder from atop the supply chamber and distributes it across the top of the build chamber. An example of such an arrangement is described in the aforementioned U.S. Pat. No. 6,036,777.

Other arrangements for feeding powder to the build chamber have been developed and are described in the art. For example, German published patent application DE 199 52 998 A1 filed by Exner et al. and published on May 17, 2001, discloses a device and method that utilizes multiple build chambers in a SFFF process. The multiple build chambers are contained within and define interior sectors of an outer cylinder. Powder supply reservoir sectors are interspersed between the build chambers. The outer chamber is fitted with a rotatable top cover which has powder spreader devices protruding from its lower surface. Rotation of the top cover causes powder to be spread from the powder supply reservoirs onto the build chambers.

Another example is found in Patent Cooperation Treaty published application WO 2004/014637, filed by Eos GmbH Electro Optical Systems and published Feb. 19, 2004. This application discloses a device and method for the solid free-form fabrication of objects in one or more build chambers. The build chambers are sectors of an outer containment cylinder and separate imaging devices are used for each of the build chambers. None of the sectors of the containment cylinder are used as powder supply reservoirs. Instead, powder is fed from overhead, radially extending feeders as the build chambers rotate under them.

Another example is found in U.S. Patent Application Publication US 2001/0050448 A1 of Kubo et al., published Dec. 13, 2001. This application discloses a powder supply reservoir that is configured to mover along the travel direction of a powder spreader mechanism for supplying the powder material ahead of the powder spreader mechanism along the travel direction to form a layer of the powder upon a build chamber.

Another example is found in U.S. Pat. No. 6,799,959 to Tochimoto et al. issued Oct. 5, 2004. This patent discloses dispensing powder from a fixed powder supply reservoir onto a powder receiving surface from which it is spread by a powder spreader mechanism across a build chamber to form a layer of powder.

Additional examples of arrangements for feeding powder to the build chamber are found in: U.S. Pat. No. 6,672,343 to Perret et al., issued Jan. 6, 2004; U.S. Pat. No. 6,136,257 to Graf et al., issued Oct. 24, 2000; U.S. Pat. No. 6,811,744 to Keicher et al., issued Nov. 2, 2004; U.S. Pat. No. 5,387,380 to Cima et al., issued Feb. 7, 1995; U.S. Pat. No. 6,007,318 to Russell et al., issued Dec. 28, 1999.

Despite the variety of powder build material supply mechanisms heretofore developed in the art, some improvement in the convenience of powder handling is still to be achieved and the present invention addresses this need.

### SUMMARY OF THE INVENTION

Accordingly, the present invention provides means and method for supplying SFFF build material powder in a convenient fashion. With regard to the means, the present invention provides an SFFF apparatus having a movable powder supply reservoir for dispensing build material powder onto a receiving surface and a powder wiping mechanism for transferring the dispensed powder from the receiving surface to a build chamber so as to form a uniform powder layer across a build platform or a powder bed of the build chamber. The mobility of the powder supply reservoir provides for ease of filling and servicing the powder supply reservoir.

In some preferred embodiments of the present invention, the powder supply reservoir translates linearly with respect to the receiving surface. In some preferred embodiments of the present invention, the powder supply reservoir translates rotationally about a supporting pivot. Other embodiments use a combination of linear and rotational translation of the powder supply reservoir.

In preferred embodiments of the present invention, the SFFF apparatus also includes a housing that encloses the powder supply reservoir, the receiving surface, and the build chamber during the article building operation. In such embodiments, it is preferred that the mobility of the powder supply reservoir permits the powder supply reservoir to translate and/or rotate out of the housing for filling or servicing.

With regard to the method, the present invention provides methods free-form fabricating articles using the apparatus of the present invention.

The apparatuses and methods of the present invention may be employed with any SFFF process that employs a powder supply reservoir. Such processes include 3DP, SLS, selective laser melting, and electron beam free-form fabrication processes. As used herein and in the appended claims, the term “powder supply reservoir” refers to any receptacle that acts as reservoir from which the powder for the SFFF process is supplied. The term includes, for example, powder bins, reusable powder supply cartridges, and disposable powder supply cartridges.

### BRIEF DESCRIPTION OF THE DRAWINGS

The criticality of the features and merits of the present invention will be better understood by reference to the attached drawings. It is to be understood, however, that the drawings are designed for the purpose of illustration only and not as a definition of the limits of the present invention.

FIG. 1 is a partial perspective view a SFFF apparatus embodiment of the present invention wherein the powder supply reservoir is in the dispensing position and is supported by two horizontally retractable support arms.

FIG. 2. is a partial perspective view of the SFFF apparatus of FIG. 1 showing the powder supply reservoir in the service position outside of the housing of the SFFF apparatus.

FIG. 3 is a perspective view of another SFFF apparatus embodiment of the present invention wherein the powder supply reservoir is in the dispensing position and is supported by a support pivot.

FIG. 4 is a perspective view of the SFFF apparatus of FIG. 3 showing the powder supply reservoir in the service position outside of the SFFF housing.

FIG. 5 is a top or plan view of another SFFF apparatus embodiment of the present invention showing the powder supply reservoir in the service position and supported by a support pivot having retractable support arms.

### DESCRIPTION OF THE PREFERRED EMBODIMENTS

In this section, some presently preferred embodiments of the present invention are described in detail sufficient for one skilled in the art to practice the present invention.

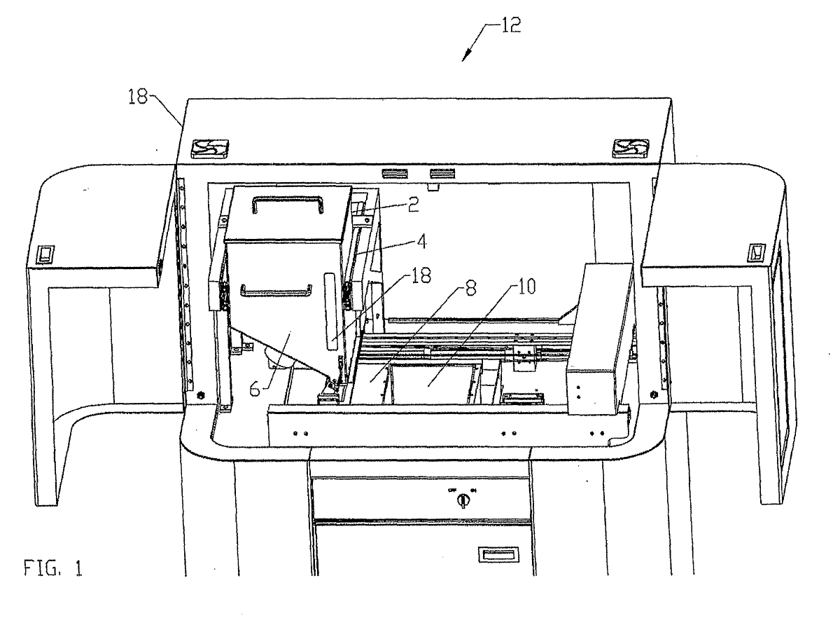

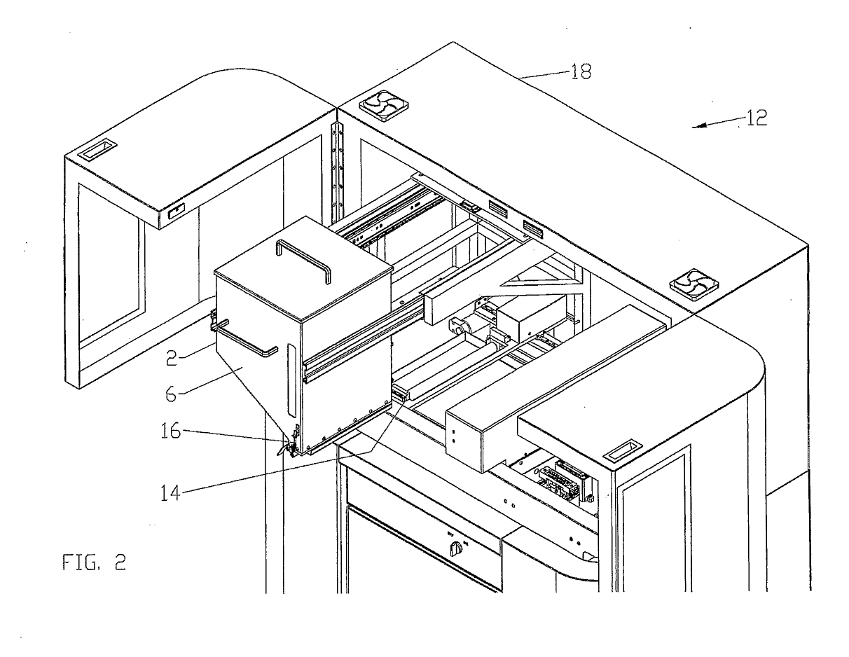

Referring to FIGS. 1 and 2, which show an embodiment of the present invention, a powder reservoir 2 supported on one or more horizontally retractable support arms 4 and having a gated tapered bottom section 6 is provided for supplying the build material powder to a receiving surface 8 that is parallel to the top of the build chamber 10 of the three-dimensional printing SFFF apparatus 12. FIG. 1 shows the powder supply reservoir in the dispensing position, i.e., the position at which it dispenses powder for the SFFF building operation. FIG. 2 illustrates the powder supply reservoir 2 extended outwardly on the horizontally retractable support arms 4 to the servicing position, i.e., the position at which the powder supply reservoir may be serviced, e.g., by filling, cleaning, replacement, etc.

Referring still to FIGS. 1 and 2, a powder wiper mechanism 14 transfers the dispensed powder from the receiving surface 8 onto the build chamber 10 in a conventional fashion. Preferably, the powder dispensing operation of the powder dispensing mechanism 16 of the powder supply reservoir 2 is activated by interaction of a feature of the wiping mechanism 12 with a feature of the powder dispensing mechanism 16. A control system (not shown) is provided to control the length of time in which the powder is dispensed. Preferably, the powder dispensing mechanism 16 dispenses a uniform ridge of build material powder onto the receiving surface 8 which, upon transfer by the wiping mechanism 14, provides the build chamber 10 with a uniform layer of powder. Also preferably, the opening width of the powder dispensing mechanism 16 is controllably adjustable, either manually or through motorized control. Thus, in preferred embodiments, the amount of build material dispensed is controllable by adjusting the opening width of the powder dispensing mechanism 16 and the amount of time the powder dispensing mechanism 16 dispenses powder.

The one or more horizontally retractable support arms 4 allow the powder supply reservoir 2 to be moved outwardly from the dispensing for easy filling, emptying, or replacement. In some embodiments of the present invention, the one or more horizontally retractable supports 4 are telescoping roller-mounted beams. An example of such horizontally retractable supports 4 is telescoping drawer supports such as shown in FIGS. 1-2. Mounting the powder supply reservoir 2 on the one or more horizontally retractable supports 4 is especially beneficial when the SFFF apparatus is fully enclosed in a housing during operation, e.g., the apparatus 12 in the housing 16, as it allows the servicing position to be outside of the housing. The powder supply reservoir 2 may be fixedly mounted on the one or more horizontally retractable supports 4, but is preferably removably mounted thereupon.

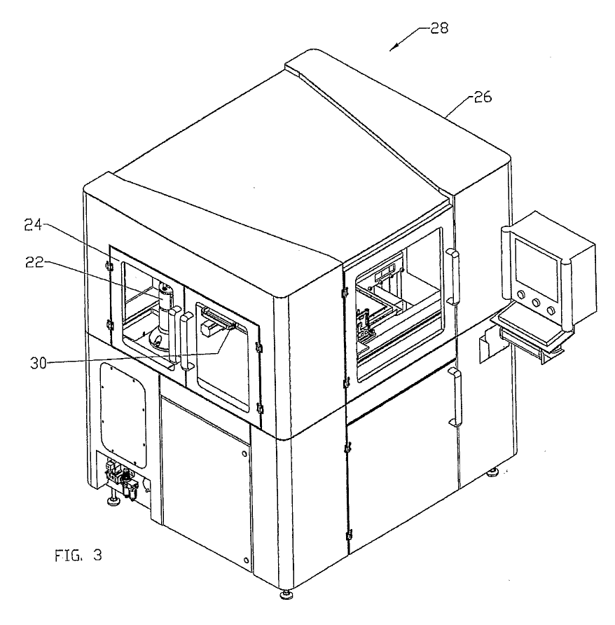

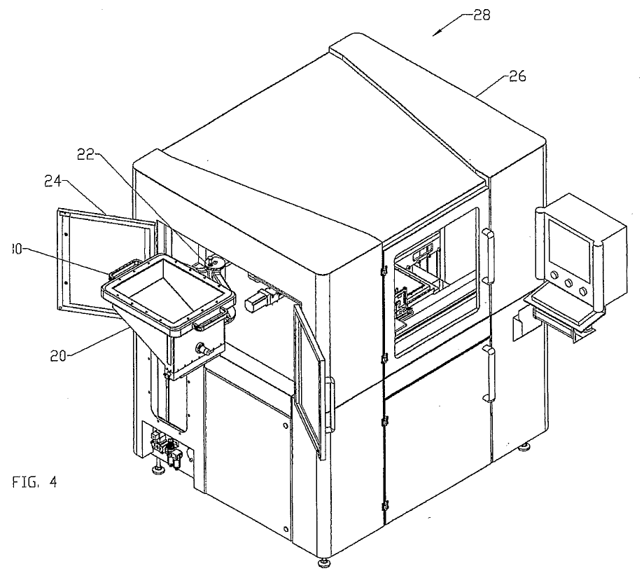

Referring now to FIGS. 3 and 4, an alternative embodiment of the present invention is illustrated in which the powder supply reservoir 20 translates rotationally around a support pivot 22. In FIG. 3, the access doors 24 on housing 26 of the SFFF apparatus 28 that are nearest the powder supply reservoir 20 are shown in the closed position and the powder supply reservoir 20 (of which only handle 30 is visible) is in the dispensing position. In FIG. 4, the access doors 24 are open and the powder supply reservoir 20 has been rotated out of the housing 26 around the support pivot 22 into the servicing position.

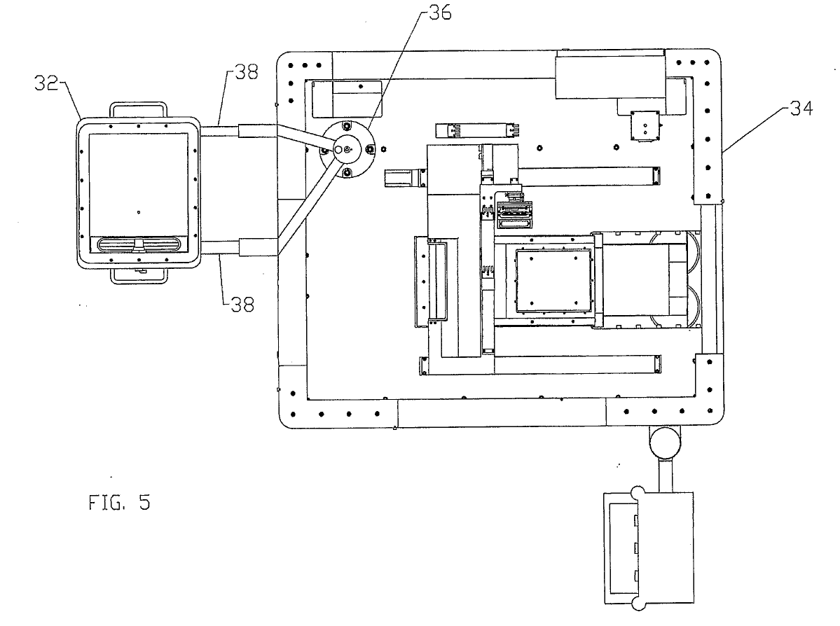

FIG. 5 shows an embodiment of the present invention in which the powder supply reservoir 32 translates both rotationally and horizontally. FIG. 5 shows a top view of a SFFF apparatus 34 in which no housing is shown. The powder supply reservoir 32 is shown in the servicing position. In this embodiment, the powder supply reservoir 32 is rotatable about the support pivot 36 and translates horizontally along the telescoping support arms 38.

The present invention contemplates that the movement of the powder supply reservoir between the servicing and dispensing positions may be accomplished either manually, by a switch or button activated motor, or completely automatically.

In some embodiments of the present invention, the powder supply reservoir is filled with build material powder remotely and then loaded onto the one or more horizontally retractable supports for use. In such a case, the powder supply reservoir may be reusable or disposable. Such embodiments are particularly preferred when the powder comprises a substance which has a limited shelf life, e.g., one that reacts with air, and the powder supply reservoir is sealed to contain a protective atmosphere or vacuum after filling.

In some embodiments of the present invention, the powder supply reservoir is adapted to receive a sealed container of build material powder. After the sealed container is placed into the powder supply reservoir, the atmosphere of the powder supply reservoir may be adjusted, if desired, to an atmosphere that will preserve the reactive species of the powder in their reactive state. In these embodiments, the powder supply reservoir includes a mechanism for opening the sealed container, e.g., through perforation, so that the powder contained therein may be dispensed from the powder supply reservoir.

Preferably, the powder supply reservoir is constructed of a light-weight and durable material that does not contaminate or react with the build material powders with which it is to be used. Preferably, the powder supply reservoir is constructed from stainless steel sheet.

The powder supply reservoir is preferably sized to contain substantially more powder than the build chamber to allow for powder loss during spreading. More preferably, the powder supply reservoir volume is in the range of between 1.5 to 2 times the volume of the build chamber.

The powder supply reservoir preferably includes a lid that may be removable or hingably attached. The powder supply reservoir may be provided with ports or nipples, e.g., quick-connect fittings, for attachment to gas supply, exhaust, or evacuation lines. Note that the structural design of the powder supply reservoir must accommodate the desired internal pressure or vacuum level to which the powder supply reservoir is expected to be subjected at any time during its use. The powder supply reservoir may be provided with seals at its lid and powder dispensing mechanism so that a controlled atmosphere may be maintained within the powder supply reservoir, e.g., of an inert gas. The powder supply reservoir may also be provided with cooling/heating device, e.g., a contact or immersion heat exchanger, for controlling the temperature of the build material powder. Temperature control of the powder within the powder supply reservoir may also be achieved through control of the temperature of a gas introduced into the powder supply reservoir.

One or more vibrators may be attached to the powder supply reservoir or its supports. Alternatively, one or more vibrating wands may be brought into contact with the powder supply reservoir or its supports. Preferably, the vibration is applied to the tapered section of the powder supply reservoir to promote powder movement and to combat any tendency the powder may have to bridge.

As shown in FIG. 1, a sight window 18 may be provided along a side of the powder supply reservoir 2 for viewing the amount of powder in the powder supply reservoir. The sight window is preferably calibrated to indicate the volume of powder remaining in the powder supply reservoir.

A sensor or sensors may be provided to measure the weight of the powder within the powder supply reservoir. For example, such sensors may be located at the points at which the powder supply reservoir is supported. In embodiments having such sensors, the weight measurements may be used to control powder dispensation. Similarly, one or more weight sensors may be provided to the powder receiving surface.

A sensor or sensors may be provided for monitoring the uniformity of the powder dispensing across the width of the deposited powder ridge. The sensors can signal the operator when the uniformity falls below a critical level. Alternatively, the sensors may activate an automated readjustment of the powder dispensing gate, vibrator or vibrators, and/or length of dispensing period. The sensors may also be used to activate an optional cross-wiper to wipe across the build chamber in a direction perpendicular to the powder transfer wiper mechanism direction of movement so as to smooth out any high spots. Another alternative is for the sensors to activate a cross-wiper mechanism to move across the dispensed powder ridge to smooth it out or to remove it from the powder receiving surface into a waste receptacle.

A method embodiment of the present invention will now be described. The present invention may be used with any powder, including metal, ceramic, polymer, and composite powders. However, in this illustrative embodiment, the operation is described with the use of a treated casting sand to make a casting mold by 3DP. The casting sand is treated with a resin, such as a phenole-formaldehdye resin as is disclosed in U.S. Pat. No. 6,147,138 to Hochsmann et al., issued Nov. 14, 2000, or other suitable activator as known in the art, e.g., Product No. FA001 available from Voxeljet, Augsburg, Germany. The application of certain kinds of printing fluid, such as one containing alcohol or an acid, e.g., hydrochloric acid, as disclosed in the aforementioned U.S. Pat. No. 6,147,138, or other suitable binders as known in the art, e.g., Product No. FB001 available from Voxeljet, Augsburg, Germany, which reacts with the resin or activator, bind the sand into a hard agglomeration in the shape printed.

In the method, the fluid reservoirs of the 3DP apparatus for the printing and cleaning fluids are filled and the waste reservoir is emptied. The computer is programmed with the image file for the mold that is to be made and the operating programs for the 3DP apparatus. The print head may be tested for good operability. The waste powder receptacle is emptied and all stray powder is removed from the operating portions of the apparatus. The build chamber platform is raised to a position that is one powder layer height below the build chamber's top rim. The powder supply reservoir is extended outwardly from the apparatus housing. The powder supply reservoir lid is removed and a volume of treated sand is charged into the powder supply reservoir. The volume charged is preferably between 1.5 and 2 times the volume of the build chamber that is to be used in the mold building operation. The lid is placed back on the powder supply reservoir. The powder supply reservoir is then fully retracted into the housing of the apparatus. If desired, the operation of the powder dispensing mechanism may be tested and adjustments made to its slide gate position, the opening time, the time of vibration, and any other controllable feed system variables.

The housing of the apparatus is closed up and the building operation is initiated by way of the computer. The wiper mechanism is brought into engagement with the tabs of the powder dispensing mechanism to pivot the powder dispensing mechanism's closure open. Just prior to, or at the moment the wiper mechanism engages the tabs, the vibrator is turned on to agitate the powder within the powder supply reservoir. Powder dispenses onto the powder receiving service until a sufficient amount of powder is dispensed to provide the first powder layer of the build chamber. The wiper mechanism is then moved away from the tabs, thus causing the spring-biased closing of the powder dispensing mechanism's closure. The vibrator is turned off. The wiper mechanism is operated to distribute the dispensed ridge of powder across the top of the build chamber. The print head is then operated to print the first layer image of the mold onto the powder. Alternatively, one or more layers of powder may be deposited in the build chamber before the print head is first operated. The print head is then returned to its home position via the cleaning station. The build platform is indexed downwardly one layer height, the wiper mechanism is brought back into engagement with the tabs of the powder dispensing mechanism, and the vibrator is again turned on. The cycle is repeated until the building of the mold has been completed. After the mold has sufficiently hardened, the build platform is raised so that the mold can be removed.

While only a few embodiments of the present invention have been shown and described, all modifications and changes that may be made thereunto by a person of ordinary skill in the art are to be considered as being within this disclosure. All United States Patents and United States Patent Publications, and Patent Cooperation Treaty Published Patent Applications identified herein are incorporated herein by reference in their entireties. The terms used in the appended claims are meant to be understood in view of the teachings herein and of the meanings afforded to said terms herein. Furthermore, in the event that a claim term is expressly defined by the applicants during the prosecution of this application before a patent office, that definition is to be used in construing the claim term during all proceedings before that patent office and in the patent granted or issued on this application by that patent office and that definition also hereby is expressly incorporated herein by reference as the applicants' definition for the claim term.

1-4. (canceled)

5. A solid free-form fabrication apparatus for solid free form fabrication of articles from a build material powder, said apparatus comprising a powder supply reservoir and a vertical support pivot, said powder supply reservoir being supported by said support pivot, said support pivot having sufficient rotatability in a substantially horizontal plane to permit said powder supply reservoir to move between a servicing position and a dispensing position.

6. The apparatus of claim 5, wherein said powder supply reservoir is removably attached to said support pivot.

7. The apparatus of claim 5, wherein said apparatus is adapted for fabricating articles by one selected from the group consisting of three-dimensional printing, selective laser sintering, selective laser melting, and electron beam free-form fabrication processes.

8. A solid free-form fabrication apparatus for solid free form fabrication of articles from a build material powder, said apparatus comprising a powder supply reservoir and a support pivot, said powder supply reservoir being supported by said support pivot, said support pivot having a horizontally retractable arm and a combination of rotatability and retractability sufficient to permit said powder supply reservoir to move between a servicing position and a dispensing position.

9. The apparatus of claim 8, wherein said powder supply reservoir is removably attached to said support pivot.

10. The apparatus of claim 8, wherein said horizontally retractable arm has a telescoping roller-mounted beam.

11. The apparatus of claim 8, wherein said apparatus is adapted for fabricating articles by one selected from the group consisting of three-dimensional printing, selective laser sintering, selective laser melting, and electron beam free-form fabrication processes.

12-14. (canceled)

15. A method for solid free-form fabrication of an article from a build material powder, said method comprising the steps of:
a) supporting a powder supply reservoir with a vertical support pivot;
b) rotating said powder supply reservoir in a substantially horizontal plane around said support pivot to move said powder supply reservoir from a servicing position to a dispensing position; and
c) dispensing powder from said powder supply reservoir during said solid free-form fabrication of said article.

16. The method of claim 12, further comprising the step of solid free-form fabricating said article by one selected from the group consisting of three-dimensional printing, selective laser sintering, selective laser melting, and electron beam free-form fabrication processes.

17. The method of claim 12, wherein said step of supporting includes removably attaching said powder supply reservoir to said support pivot.

18. A method for solid free-form fabrication of an article from a build material powder, said method comprising the steps of:
a) supporting a powder supply reservoir with a support pivot, said support pivot having a horizontally retractable arm;
b) rotating said support pivot and retracting said horizontally retractable arm to move said powder supply reservoir from a servicing position to a dispensing position; and
c) dispensing powder from said powder supply reservoir during said solid free-form fabrication of said article.

19. The method of claim 18, further comprising the step of solid free-form fabricating said article by one selected from the group consisting of three-dimensional printing, selective laser sintering, selective laser melting, and electron beam free-form fabrication processes.

20. The method of claim 18, wherein said step of supporting includes removably attaching said powder supply reservoir to said support pivot.
